(19) United States
(12) Patent Application Publication
(10) Pub. No.: US 2002/0135253 A1
(43) Pub. Date: Sep. 26, 2002

(54) Rotor assembly for variable torque constant brushless motors

(76) Inventors: Tomy Sebastian, Saginaw, MI (US); Sunil Keshava Murthy, Austin, TX (US)

Correspondence Address: EDMUND P. ANDERSON, DELPHI TECHNOLOGIES, INC., Legal Staff, Mail Code: 480-414-420, P.O. Box 5052, Troy, MI, 48007-5052, US

(21) Appl. No.: 09/815,085

(22) Filed: Mar. 22, 2001

(51) Int. Cl. H02K 21/12; H02K 1/24

(52) U.S. Cl. 310/156.48; 310/269

(57) ABSTRACT

A rotor assembly for a brushless motor is disclosed. In an exemplary embodiment of the invention, the rotor assembly includes a core having a central opening for insertion of a rotor shaft therein. A plurality of rotor magnets disposed upon a periphery of the core, wherein a space is defined between one of the plurality of rotor magnets and another of the plurality of rotor magnets. A portion of said core occupies said space, thereby defining a salient pole therewithin.

### BACKGROUND

Brushless motors presently in existence generally include a rotor assembly having one or more rotor magnets disposed on the periphery thereupon. The rotor magnets, when positioned upon the periphery of a rotor, may cover the entire outer surface of the rotor. Alternatively, a plurality of rotor magnets may have gaps or spaces located between each individual magnet, which gaps are either typically filled with a non-magnetic material or are left unfilled. In either case, the torque produced by a motor having such a rotor assembly is linearly proportional to the current applied. Thus, the motor torque constant K, (torque per unit current) will not vary over a given range of operating speeds.

However, in certain applications using brushless motors, such as electric power steering systems, it may desirable to have a relatively high applied torque at low motor speeds and a relatively low applied torque at high motor speeds.

### SUMMARY

The problems and disadvantages of the prior art are overcome and alleviated by a rotor assembly for a brushless motor. In an exemplary embodiment of the invention, the rotor assembly includes a core having a central opening for insertion of a rotor shaft therein. A plurality of rotor magnets disposed upon a periphery of the core, wherein a space is defined between one of the plurality of rotor magnets and another of the plurality of rotor magnets. A portion of said core occupies said space, thereby defining a salient pole therewithin.

In a preferred embodiment, the brushless motor has a total output torque having a first torque component and a second torque component. The first torque component is proportional to the applied current to the brushless motor and the second torque component is proportional to the square of the applied current to the brushless motor. Furthermore, the first torque component is generated as a result of the interaction between the plurality of rotor magnets and the magnetomotive force generated in a stator of the brushless motor. The first torque component is maximized when the angle between the stator magnetomotive force and a pole axis defined by a pair of the plurality of rotor magnets is about 90 degrees. In contrast, the second torque component is generated as a result of the interaction between the plurality of salient poles and the magnetomotive force generated in the stator of the brushless motor. The second torque component is maximized when the angle between said stator magnetomotive force and a pole axis defined by a pair of said plurality of rotor magnets is about 135 degrees.

### BRIEF DESCRIPTION OF THE DRAWINGS

The present invention will now be described, by way of example only, with reference to the accompanying drawings which are meant to be exemplary, not limiting, and wherein like elements are numbered alike in several Figures, in which:

FIG. 1 is a schematic diagram of an electric power steering system using a polyphase brushless motor in accordance with an embodiment of the invention;

FIG. 2 is a cross sectional view of an existing rotor configuration for a brushless motor;

FIG. 3 is a cross sectional view of another existing rotor configuration for a brushless motor;

FIG. 4 is a cross sectional view of another existing rotor configuration for a brushless motor;

FIG. 5 is a cross sectional view of a rotor assembly for a brushless motor, in accordance with an embodiment of the invention;

FIG. 6 is an alternative embodiment of the rotor assembly of FIG. 5; and

FIG. 7 is a graph illustrating the torque versus angle characteristics for the rotor assembly shown in FIG. 5.

### DETAILED DESCRIPTION

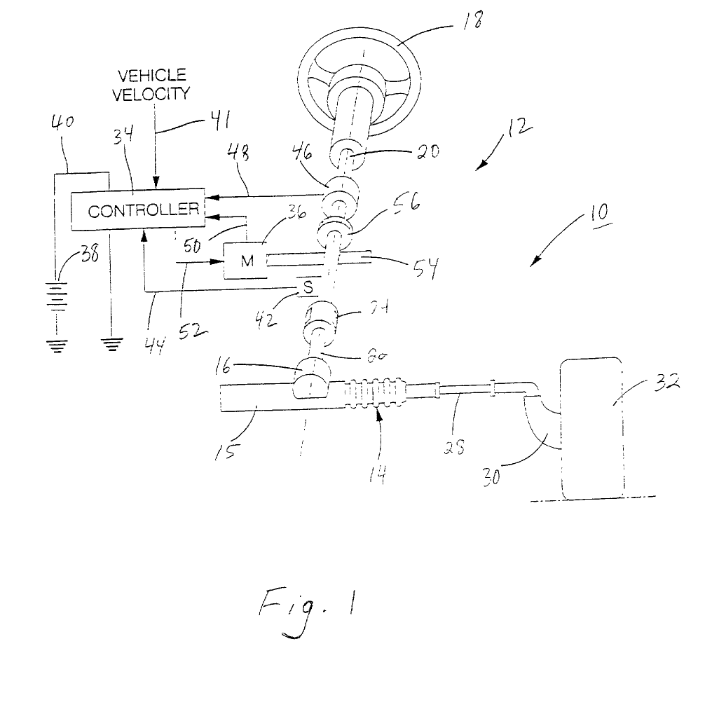

Referring initially to FIG. 1, a motor vehicle 10 is provided with an electric power steering system 12. Electric power steering system 12 may include a conventional rack and pinion steering mechanism 14 having a toothed rack 15 and a pinion gear (not shown) under a gear housing 16. As steering wheel 18 is turned, an upper steering shaft 20 turns a lower shaft 22 through a universal joint 24. Lower steering shaft 22 turns the pinion gear. The rotation of the pinion gear moves the rack 15, which then moves tie rods 28 (only one shown). In turn, tie rods 28 move steering knuckles 30 (only one shown) to turn wheels 32.

An electric power assist is provided through a controller 34 and a power assist actuator comprising a motor 36. Controller 34 receives electric power from a vehicle electric power source 38 through a line 40. The controller 34 also receives a signal representative of the vehicle velocity on line 41, as well as steering pinion gear angle from a rotational position sensor 42 on line 44. As steering wheel 18 is turned, a torque sensor 46 senses the torque applied to steering wheel 18 by the vehicle operator and provides an operator torque signal to controller 34 on line 48. In addition, as the rotor of motor 36 turns, rotor position signals for each phase are generated within motor 36 and provided over bus 50 to controller 34. In response to vehicle velocity, operator torque, steering pinion gear angle and rotor position signals received, the controller 34 derives desired motor phase currents. The motor phase currents are provided to motor 36 through a bus 52 to motor 36, which thereby provides torque assist to steering shaft 20 through worm 54 and worm gear 56.

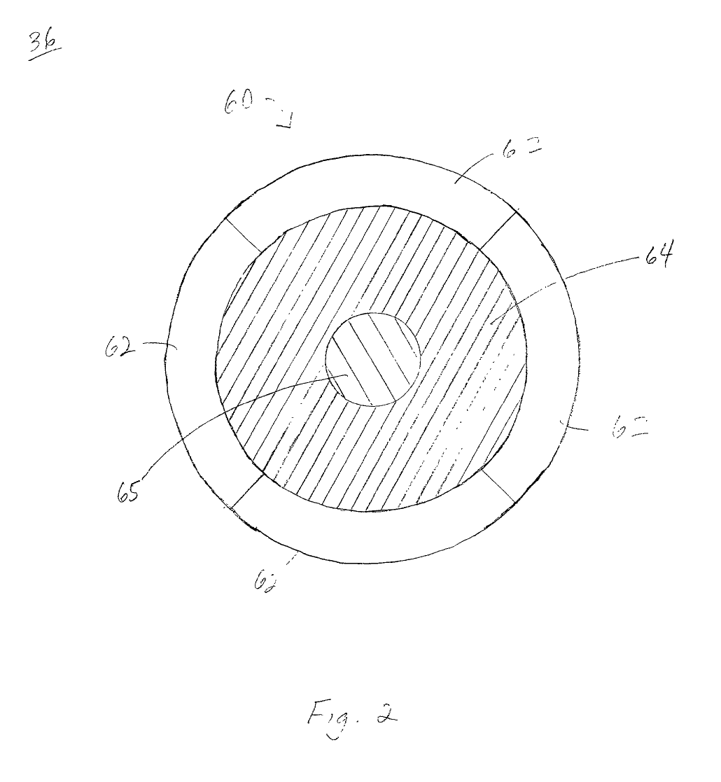

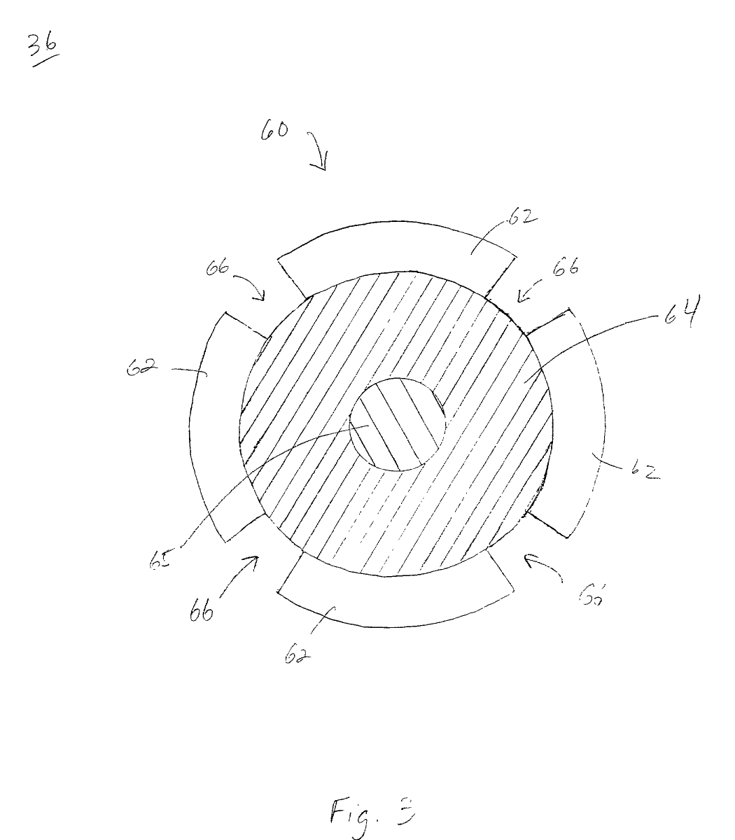

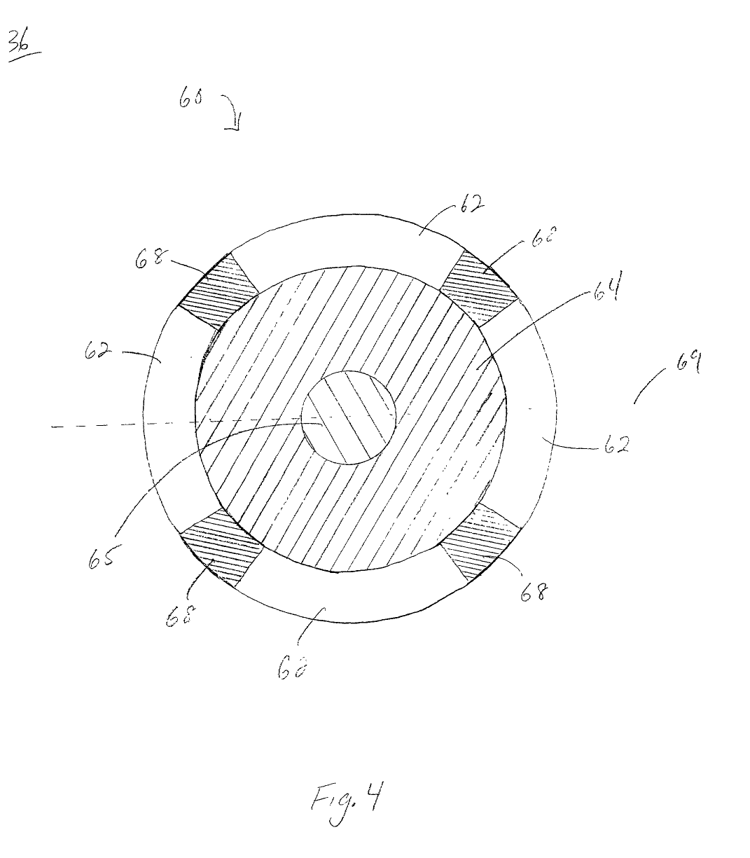

Referring now to FIG. 2, an existing motor 36 features a rotor assembly 60 having a plurality of rotor magnets 62 circumferentially mounted upon a core 64. A rotor shaft 65 is inserted through an opening in core 64. The core 64 is circular in shape and may comprise a plurality of lamina of soft iron, steel or other magnetic material. In the embodiment shown, the rotor magnets 62 completely cover the outer surface of the core 64. Alternatively, FIG. 3 illustrates the rotor assembly 60 wherein the rotor magnets 62 do not entirely cover the outer surface of core 64. In this case, a space 66 is defined in between each pair of adjacent magnets 62, which space 66 is either left unfilled or is filled with non-magnetic material 68, such as a plastic mold filler, shown in FIG. 4.

In each of the existing rotor assembly 60 configurations shown in FIGS. 2-4, the output torque of the motor 36 is directly proportional to the motor current. Furthermore, the output torque is maximized when the angle between the rotor pole axis 69 (shown by way of example in FIG. 4) for a given pair of rotor magnets 62 and the magnetomotive force generated in the stator (not shown) is at 90 electrical degrees with respect to one another. In terms of the torque produced per unit current, or torque constant K_{τ}, this value remains a constant over the range of motor operating speeds.

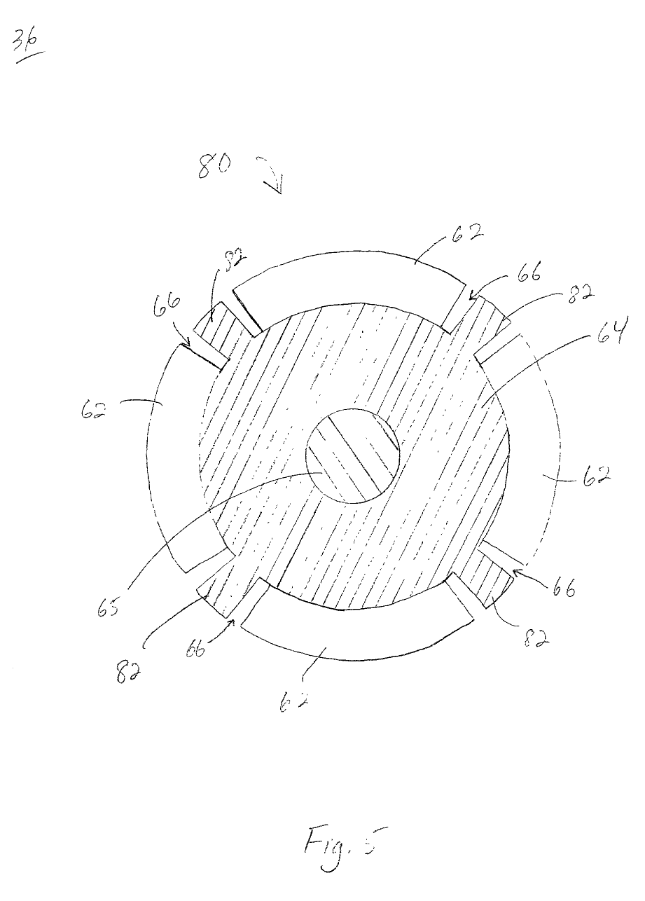

Therefore, in accordance with an embodiment of the invention, a rotor assembly 80 for a brushless motor is shown in FIG. 5. For ease of description, like elements appearing in the prior Figures are shown with the same reference numerals and component designations. In addition to the elements previously described, a space 66 is defined between each pair of adjacent magnets 62; however each space 66 is partially filled or occupied by a protruding portion of the core, thereby defining a salient pole 82 within each space. The sailent poles 82, being comprised of the same soft magnetic material as the core 64, are magnetically attracted to an energized stator coil (not shown). Thus, the salient poles 82 provide another component of torque in a comparable fashion to the rotor poles of a switched reluctance motor. More specifically, the magnetic interaction between the energized coils around the poles of the stator and the salient poles 82 produces a torque.

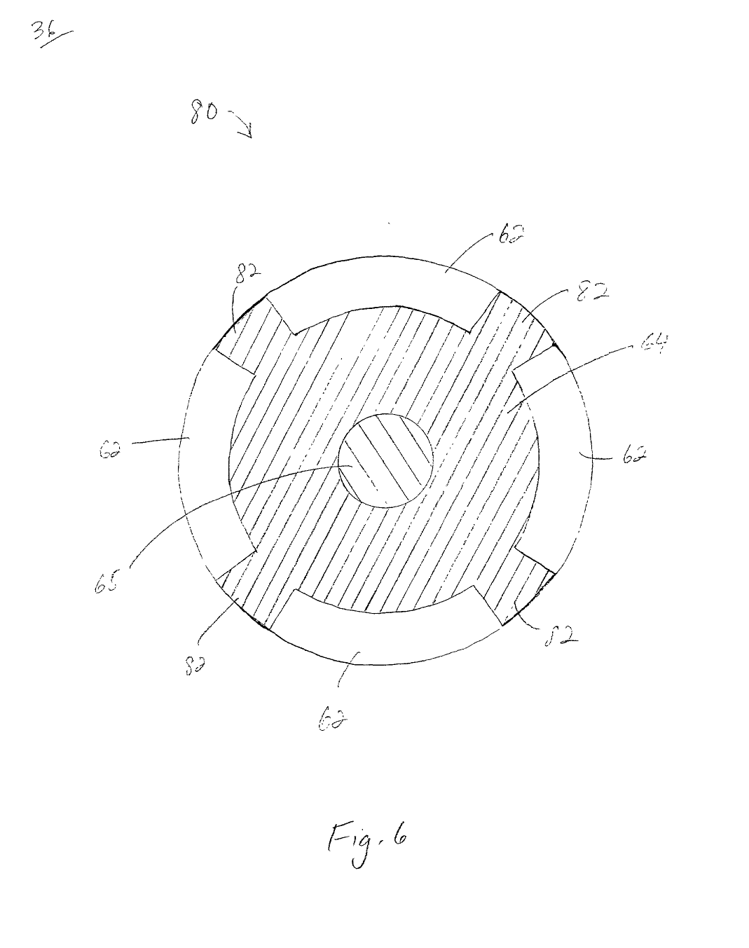

FIG. 6 is an alternative embodiment of the rotor assembly 80 shown in FIG. 5. In the embodiment shown in FIG. 6, the salient poles 82 are dimensioned such the entire space 66 between each pair of adjacent rotor magnets 62 are filled with salient pole material.

Thus configured, rotor assembly 80 therefore provides both a first torque component τ₁ and a second torque component τ₂. The first torque component τ₁, being generated by the interaction between the stator and the rotor magnets 62 is directly proportional to the applied current. The second torque component τ₂, generated as described above, is not linearly proportional to the applied motor current, but proportional to the square of the motor current. As a result, the second torque component τ₂ assists in providing an overall greater torque at lower speeds where the motor current is initially higher. In addition, since the second torque component τ₂ is also proportional to twice the angle between the rotor pole axis for a given pair of rotor magnets and the magnetomotive force generated in the stator, τ₂ is maximized at intervals of 45 electrical degrees.

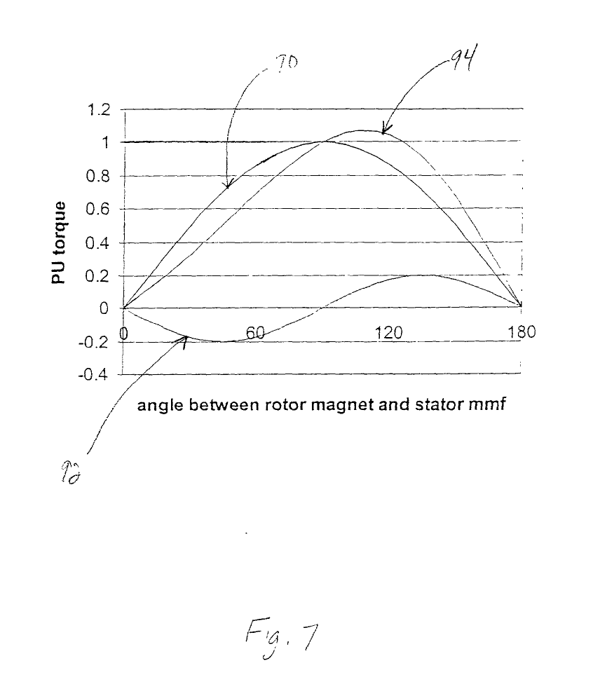

Finally, FIG. 7 illustrates the relationship between the per unit torque of the first and second torque components τ_{1,}τ₂ versus the angle between the stator magnetomotive force. Curve 90 represents the per unit torque of the first torque component τ₁, generated from the interaction between the stator mmf and the rotor magnets. As can be seen from the graph, τ₁ is maximized at a 90 degree angle. On the other hand, curve 92 represents the per unit torque of the second torque component τ₂, generated from the interaction between the stator mmf and the salient poles. During the first half cycle of curve 92, it is seen that the second torque component τ₂ opposes the first torque component τ₁, with maximum opposition occurring at an angle of 45 degrees. During the second half cycle, the second torque component τ₂ assists the first torque component τ₁, with maximum assistance at an angle of 135 degrees.

Curve 94 represents the total output torque resulting from τ₁ and τ₂. It can be seen that the maximum total output torque for motor 36, therefore, will be between 90 and 135 degrees. At relatively small motor currents, the second torque component τ₂ will have less of an effect and, thus, the maximum total torque output will occur close to 90 degrees. At higher motor currents, the second torque component will have a greater effect on total torque output. Thus, the angle at which maximum torque occurs will also increase. Over a range of operating speeds, the second torque component τ₂ contribution to the total torque will be about 0-30% of the first torque component τ₁ contribution.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A rotor assembly for a brushless motor, the rotor assembly comprising:
a core having a central opening for insertion of a rotor shaft therein;
a plurality of rotor magnets disposed upon a periphery of said core, wherein a space is defined between one of said plurality of rotor magnets and another of said plurality of rotor magnets; and
a portion of said core occupying said space, thereby defining a salient pole therewithin.

2. The rotor assembly of claim 1, wherein said brushless motor has a total output torque, said total output torque component comprising a first torque component and a second torque component.

3. The rotor assembly of claim 2, wherein said first torque component is proportional to the applied current to said brushless motor and said second torque component is proportional to the square of the applied current to said brushless motor.

4. The rotor assembly of claim 2, wherein said first torque component is generated as a result of the interaction between said plurality of rotor magnets and the magnetomotive force generated in a stator of said brushless motor.

5. The rotor assembly of claim 4, wherein said first torque component is maximized when the angle between said stator magnetomotive force and a pole axis defined by a pair of said plurality of rotor magnets is about 90 degrees.

6. The rotor assembly of claim 2, wherein said second torque component is generated as a result of the interaction between said plurality of salient poles and the magnetomotive force generated in a stator of said brushless motor.

7. The rotor assembly of claim 6, wherein said second torque component is maximized when the angle between said stator magnetomotive force and a pole axis defined by a pair of said plurality of rotor magnets is about 135 degrees.

8. The rotor assembly of claim 7, wherein said total torque is maximized when the angle between said stator magnetomotive force and said pole axis is between 90 degrees and 135 degrees.

9. The rotor assembly of claim 1, wherein said core comprises a soft magnetic material.

10. The rotor assembly of claim 2, wherein said core comprises soft iron.

11. The rotor assembly of claim 1, wherein said salient pole completely occupies said space.

12. A power assist actuator for an electric power steering system, the actuator comprising:
a brushless motor coupled to a steering shaft and providing an assist torque thereon, said motor further including a rotor assembly, said rotor assembly further comprising:
a core having a central opening for insertion of a rotor shaft therein; and
a plurality of rotor magnets disposed upon a periphery of said core, wherein a space is defined between one of said plurality of rotor magnets and another of said plurality of rotor magnets; and
a portion of said core occupying said space, thereby defining a salient pole therewithin.

13. The rotor assembly of claim 12, wherein said brushless motor has a total output torque, said total output torque component comprising a first torque component and a second torque component.

14. The rotor assembly of claim 13, wherein said first torque component is proportional to the applied current to said brushless motor and said second torque component is proportional to the square of the applied current to said brushless motor.

15. The rotor assembly of claim 13, wherein said first torque component is generated as a result of the interaction between said plurality of rotor magnets and the magnetomotive force generated in a stator of said brushless motor.

16. The rotor assembly of claim 15, wherein said first torque component is maximized when the angle between said stator magnetomotive force and a pole axis defined by a pair of said plurality of rotor magnets is about 90 degrees.

17. The rotor assembly of claim 13, wherein said second torque component is generated as a result of the interaction between said plurality of salient poles and the magnetomotive force generated in a stator of said brushless motor.

18. The rotor assembly of claim 17, wherein said second torque component is maximized when the angle between said stator magnetomotive force and a pole axis defined by a pair of said plurality of rotor magnets is about 135 degrees.

19. The rotor assembly of claim 18, wherein said total torque is maximized when the angle between said stator magnetomotive force and said pole axis is between 90 degrees and 135 degrees.

20. The rotor assembly of claim 12, wherein said core comprises a soft magnetic material.

21. The rotor assembly of claim 13, wherein said core comprises soft iron.

22. The rotor assembly of claim 12, wherein said salient pole completely occupies said space.
